(19) United States
(12) Patent Application Publication
(10) Pub. No.: US 2019/0228604 A1
(43) Pub. Date: Jul. 25, 2019

(54) LORA-BASED LOCK SYSTEMS AND METHODS

(71) Applicant: Sargent Manufacturing Company, New Haven, CT (US)

(72) Inventor: Mark Bryla, Cumming, GA (US)

(21) Appl. No.: 16/255,166

(22) Filed: Jan. 23, 2019

Related U.S. Application Data
(60) Provisional application No. 62/621,455, filed on Jan. 24, 2018.

(51) Int. Cl. G07C 9/00; E05B 47/00

(52) U.S. Cl. CPC G07C 9/00182; G07C 2009/00206; E05Y 2900/132; E05B 47/0001

(57) ABSTRACT

A lock system may include a lock unit and a gateway. The lock unit may include a first wireless communicator that is configured to communicate via a LoRa-based wireless communication link to initiate one or more operations, status inquiries, and/or lock unit updates of the lock unit. In some embodiments, the lock unit may also include one or more components that may be maintained in a powered-off and/or low-power standby state when not in use. The lock unit may activate power to these one or more components, including activating a second wireless communicator, for example, after receiving a wakeup signal from the gateway. The lock unit and the gateway may communicate requests for low bandwidth data transfer via the first wireless communicator and requests for high bandwidth data transfer via the second wireless communicator.

### RELATED APPLICATIONS

This application claims the benefit under 35 U.S.C. § 119(e) to U.S. Provisional Application Ser. No. 62/621,455, filed Jan. 24, 2018, entitled “LORA-BASED LOCK SYSTEMS AND METHODS” which is herein incorporated by reference in its entirety.

### FIELD

Disclosed embodiments are related to lock systems and their methods of operation.

### BACKGROUND

Locks for entryways such as doors often include a locking component such as a deadbolt or latch that is movable between an unlocked position to permit opening of the door, and a locked position to lock the door in a closed position. Some lock systems may include one or more electrical components, such as electrically driven lock motors to move the locking component between the locked and unlocked positions.

### SUMMARY

In one embodiment, a lock system includes a lock movable between a locked position and an unlocked position, an actuator coupled to the lock to move the lock between the locked position and the unlocked position, a first wireless communicator configured to receive a first signal via a first wireless communication link associated with a LoRa-based communication network, and a controller operatively coupled to the first wireless communicator. The controller is configured to perform one or more operations of the lock system based on the first signal received from the first wireless communicator.

In another embodiment, a lock system includes a plurality of lock units. Each lock unit of the plurality of lock units includes a lock moveable between a locked position and an unlocked position, an actuator coupled to the lock to move the lock between the locked position and the unlocked position, a first wireless communicator configured to receive a first signal via a first wireless communication link associated with a LoRa-based communication network, and a lock unit controller operatively coupled with the first wireless communicator. The lock system further includes a gateway located remote from the plurality of lock units. The gateway includes a gateway wireless communicator configured to transmit the first signal to the first wireless communicator, and a gateway controller operatively coupled with the gateway wireless communicator.

In yet another embodiment, a method of operating a lock system includes receiving, at a first wireless communicator of a lock unit, a first signal from a gateway. The first wireless communicator is configured to communicate via a first wireless communication link associated with a LoRa-based communication network. The method further includes, receiving, at the first wireless communicator, a wakeup signal from the gateway via the first wireless communication link, and in response to the wakeup signal, activating a second wireless communicator of the lock unit. The second wireless communicator is configured to communicate via a second wireless communication link different from the first wireless communication link. The method further includes receiving, after the second wireless communicator is activated, a second signal from the gateway at the second wireless communicator.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of a lock system according to one embodiment;

FIG. 2 is a schematic representation of a lock system with a plurality of lock units according to one embodiment;

FIG. 3 is a flow chart depicting a method of operating a lock system according to one embodiment.

### DETAILED DESCRIPTION

The inventors have appreciated that entryways such as doors, gates, garages, windows, and other access regions may include electronic lock systems, which in some instances, may provide for enhanced convenience and/or security compared to conventional locks. However, the various components of electric lock systems, such as, for example, a radio frequency identification (RFID) or other near-field communication reader, a wireless communication device, a lock motor, a keypad, and/or other appropriate components use electrical power. Further, in some cases, such components may always be in a powered-on state. For example, a component such as an RFID reader (or other receiver or reader) may always be powered on and awaiting a signal, such as an unlock signal or code from a corresponding RFID device, remote keypad and/or some other wireless key.

The inventors have also appreciated that in some instances, components such as RFID readers and/or wireless communication devices, which are always powered-on and awaiting a signal (e.g., an unlock signal), may be among the largest power draws in a system. For example, an RFID reader on a lock may need to constantly emit a signal such that when a corresponding RFID device is brought into proximity with the RFID reader, the reader can detect a signal from the device. Similarly, a wireless communication device may need to be constantly powered on and maintained in a listening mode while awaiting a signal such as an unlock signal. Such constant broadcasting and/or listening may lead to significant power usage, and such components may be the primary power draw of the system. In instances where a door lock is powered by a battery, the noted constantly powered components will shorten the battery life of the lock system. Accordingly, many lock systems may use large batteries or battery assemblies and/or may need frequent replacement of the batteries to operate in this manner.

The inventors have further appreciated that typically, a large number of requests that are communicated to lock systems are requests for low bandwidth data transfer (e.g., lock or unlock requests). Thus, keeping a wireless communication device (such as, a wireless communication device that communicates via Wi-Fi technology) constantly powered on for such requests may result in unnecessary reduction in battery life.

In view of the above, the inventors have recognized numerous benefits associated with utilizing a long range, low power wireless platform (such as, LoRa—Long Range) for communicating one or more commands and/or information to and/or from one or more associated lock systems. Such a system may improve battery life and increased responsiveness to requests. Specifically, in some embodiments, a lock system that includes one or more wireless transceivers that can communicate via a LoRa-based communication network (e.g., LoRaWAN (Long Range Wide Area Network)), certain requests, such as requests for low bandwidth data transfer, can be communicated to/from the lock systems without using significant amounts of power. In addition, usage of LoRa technology, which is a sub-Gigahertz protocol, may significantly reduce interference between the one or more lock systems and other equipment located in an institution (e.g., equipment operating using higher frequency communications technology, such as, for example, equipment in a hospital environment) which operates at other frequency ranges such as in the Gighertz frequency range.

In some embodiments, a lock system may include a lock unit located on a door (or other suitable entryway), and the lock unit may communicate with at least one gateway that is located remote from the lock unit. The lock unit may include a first wireless communicator that is configured to communicate with the gateway via a LoRa-based wireless communication link. The LoRa-based wireless communication link may be used to communicate low bandwidth data transfer requests to/from the lock unit and the gateway. Examples of such requests include, but are not limited to, a lock signal for the lock system, an unlock signal for the lock system, a status request for the lock system, a response to a status request for the gateway, and a wakeup signal for the lock system. In some embodiments, in response to receiving requests/signals from the gateway, a lock controller may initiate one or more functions, for example, operating a lock actuator to move a lock between a locked position and an unlocked position in response to receiving lock or unlock signals from the gateway, determining a status of the lock (i.e., whether the lock is in a locked or an unlocked position and/or whether a latch is in the latched or unlatched position) and communicating the status to the gateway in response to status requests received from the gateway, activating one or more components associated with the lock unit in response to a wakeup signal received from the gateway, and/or other functions.

In some embodiments, the first wireless communicator of the lock unit may remain powered on to communicate requests for low bandwidth data transfer. In further embodiments, other components of the lock unit that are larger power draws than the first wireless communication may only be powered when needed. For example, such systems may avoid the need to always maintain components such as RFID readers and/or other wireless communication devices (e.g., Wi-Fi communication devices) in a powered-on state. Instead, one or more components (e.g., RFID readers and/or wireless communication devices) may be maintained in a powered-off or low-power standby state until the components are needed to be powered on, such as to detect an RFID signal, and/or to communicate with other components. After being powered on, the one or more components may be operated for as long as needed, and may subsequently be powered off and/or switched to a low-power standby state until they are later needed to be powered on again.

In some embodiments, a lock unit may include, in addition to a first wireless communicator, a second wireless communicator that is configured to communicate with the gateway via a second wireless communication link (e.g., RF, cellular, and/or Wi-Fi communication link) that is different from the LoRa-based communication link. The second wireless communication link is used to communicate high bandwidth data transfer requests to/from the lock unit and the gateway. Examples of such requests include, but are not limited to, a software and/or firmware update for the lock system, an update to an access list stored at the lock unit that includes access codes, and/or identification codes associated with different users that may be permitted to unlock the lock. As explained previously, keeping the second wireless communicator in a powered on state may significantly increase power usage. Therefore, the second wireless communicator may be maintained in a powered-off or low-power standby state until the lock unit receives a wakeup signal from the gateway using the LoRa-based communication link. For example, in some instances, the first wireless communicator on the lock unit may receive a wakeup signal from the gateway. The wakeup signal may be communicated when high bandwidth data transfer needs to take place between the lock unit and the gateway. In response to receiving the wakeup signal, the lock controller may activate power to the second wireless communicator. Once the second wireless communicator is powered on, the high bandwidth data transfer takes place between the lock unit and the gateway. When the data transfer is completed, the second wireless communicator may be powered off and/or placed in a low-power standby state. For example, in one embodiment, the gateway may send a termination signal to the lock unit via the first or second wireless communication link. In response to the termination signal, the lock controller may deactivate power to the second wireless communicator. In another embodiment, the second wireless communicator may be deactivated after an expected communication sequence between the lock unit and the gateway has finished. For example, the second wireless communicator may deactivate after a software update communication is finished. In yet another embodiment, the second wireless communicator may power down and/or enter a low-power standby state after a predetermined period of time has elapsed after activating the second wireless communicator, such as an expected amount of time to perform one or more desired functions. For example, the expected amount of time may be just an amount of time to complete a communicated task (e.g., to communicate a software update).

In some instances, the use of a long range, low power wireless platform (such as, LoRa) for a lock system combined with powering down (or maintaining a low-power standby state) of various components of the lock system that may be the larger power draws of the lock system may dramatically reduce the overall power usage of the system. This may facilitate the use of smaller batteries or extend battery life of similar sized batteries compared to lock systems that have constantly powered components. This is in addition to improvements in battery usage based on the usage of a lower power wireless communication protocol such as LoRa noted above. The inventors have appreciated that using smaller batteries and/or battery packs may, in some instances, be beneficial from a packaging perspective in addition to providing enhanced battery life and/or less battery maintenance as well.

In addition to the above, the inventors have recognized that providing at least one gateway that is capable of communicating with one or more lock systems using different wireless communication technologies (e.g., LoRa and Wi-Fi) may allow for different types of requests to be carried out in a manner that allows the power consumption to be kept to a minimum. For example, a gateway may be configured to communicate with either the first wireless communicator or the second wireless communicator based on a type of request. The gateway may communicate with the first wireless communicator of the lock system for low bandwidth data transfer requests and the second wireless communicator for high bandwidth data transfer requests. While the first wireless communicator is kept in a powered on state to communicate the low bandwidth data transfer requests, the second wireless communicator may be activated in response to a wakeup signal from the gateway. Thus, by utilizing the LoRa-based wireless platform that consumes low power for communicating low bandwidth data transfer requests and activating other wireless communicators of the lock system only when needed (e.g., for high bandwidth data transfer requests), the power consumption of the lock system may be minimized.

In some embodiments, multiple gateways may be provided for communicating with the lock systems. For example, a first gateway may be configured to communicate with the first wireless communicator via the first wireless communication link (i.e., LoRa-based communication link) and a second gateway may be configured to communicate with the second wireless communicator via the second wireless communication link (i.e., RF, cellular, Wi-Fi, and/or Bluetooth communication link). In other embodiments, a number of lock units may be configured to communicate with one or more gateways via the LoRa-based communication network.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

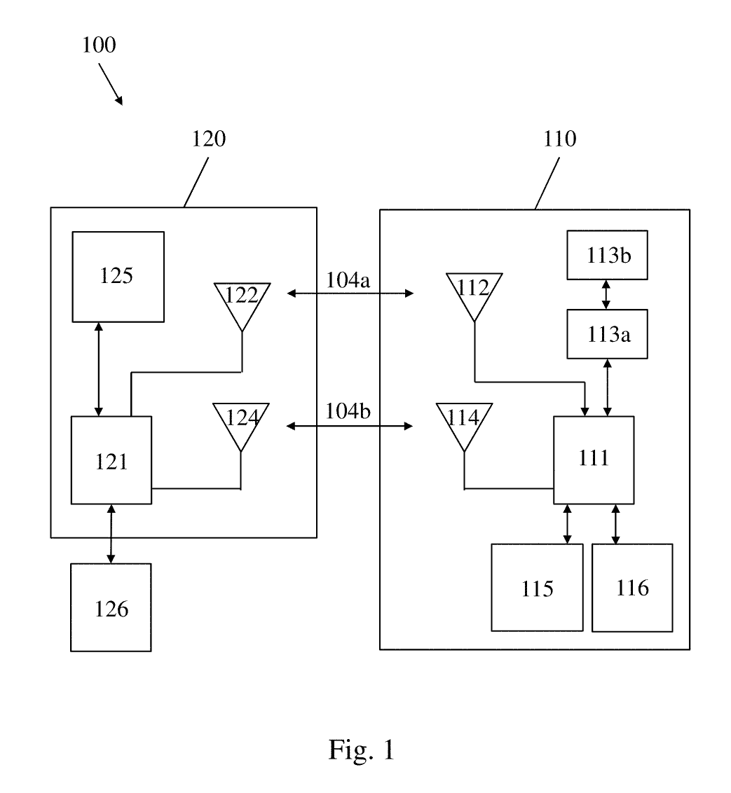

FIG. 1 is a schematic representation of one embodiment of a lock system 100 including a lock unit 110, which may be located on a door or other suitable entryway, and a gateway 120 located remote from the lock unit 110. The lock unit 110 includes a lock controller 111, coupled to a lock actuator 113a, a first wireless communicator 112, and a second wireless communicator 114. The lock unit 110 includes a lock 113b that is movable between an unlocked position and a locked position to selectively secure the door. For example, the lock 113b may include a deadbolt, a lock coupled to a latch, or any other suitable locking structure to selectively secure the door in a locked configuration and selectively restrict opening of the door, and in certain embodiments, the lock 113b may be received in a corresponding receptacle when in the locked position. However, it should be understood that the current disclosure is not limited to any particular lock structure. For example, the lock structure may simply be a latch, such as a latch of a push bar, which is a type of door opening mechanism that allows users to open a door by pushing a bar thereby retracting the door latch, as is well known. Thus, in this example, the system may be employed to determine the state of the push bar, that is whether it has been actuated or pushed to retract the latch to allow access. As such, the term “lock” is not necessarily limited herein to a structure or arrangement that prevents or allows the access but instead may refer to a latch of the door access system, and the terms “locked” and “unlocked” may refer to the latch being in a latched configuration or an unlatched configuration, respectively.

In some embodiments, the lock 113b may be operatively coupled to the lock actuator 113a (e.g., a lock motor) that may be actuated to move the lock between the locked and unlocked positions. The lock actuator 113a may be operatively coupled to the lock controller 111 that controls the operation of the lock actuator 113a based on signals received by the lock controller 111. For example, the lock controller 111 may receive an unlock signal and may operate the lock actuator 113a to move the lock 113b from the locked position to the unlocked position. Similarly, the lock controller 111 may operate the lock actuator 113a to move the lock 113b from the unlocked position to the locked position after the lock controller 111 receives a lock signal. Alternatively, the actuator may be a manual actuator, for example, the push bar as discussed above or simple a door handle. In such examples, the actuator would not be actuatable by the controller 11.

In some embodiments, the lock unit 110 may include a first user input device 115 coupled to the lock controller 111 to allow a user to provide input (e.g., an unlock code) directly on the lock unit 110. In some instances, the user input may be used to authorize entry for a particular user. In response to the user input, the lock controller 111 may operate the lock actuator 113a to move the lock 113b between the locked and unlocked position as desired.

In one embodiment, the lock unit 110 may include a first wireless communicator 112 arranged to wirelessly communicate with a first gateway wireless communicator 122 located on the gateway 120 via a first wireless communication link 104a associated with a LoRa-based communication network, for example, LoRaWAN. As discussed above, LoRa is a long range, low power wireless platform that enables low data rate communications over long distances. The first wireless communicator 112 may be maintained in a powered-on state because of its low power consumption. The lock unit 110 may further include a second wireless communicator 114 arranged to wirelessly communicate with a second gateway wireless communicator 124 located on the gateway 120 via a second wireless communication link 104b that is associated with a different wireless communication network, for example, a Wi-Fi, RF, or cellular network. The second wireless communicator may maintained in a powered-off state or low-power standby state, and may be activated when needed because of its high power consumption.

In some embodiments, a gateway controller 121 of gateway 120 may operate the first gateway wireless communicator 122 to send low bandwidth data transfer requests and/or signals to the first wireless communicator 112 such that the lock unit 110 performs a first set of functions and/or operations. The low bandwidth data transfer requests may include lock or unlock signals, wakeup signals, status requests, etc. For instance, the gateway 120 may transmit a lock or unlock signal to the lock unit 110 via the first gateway wireless communicator 122 and the first wireless communicator 112. After the signal is received by the lock unit 110, lock controller 111 may operate the lock actuator 113a to move the lock 113b between a locked position and unlocked position as desired. In another instance, the gateway 120 may transmit a status request to the lock unit 110 via the first gateway wireless communicator 122 and the first wireless communicator 112. After the status request is received, the lock controller 111 may gather information such as a position of the lock (e.g., locked or unlocked), how long the door and/or lock has been in a particular state, the charge level of a battery on the lock unit, and so on using information transmitted from the one or more associated components and/or one or more associated sensors. Where the data represents low bandwidth data, the lock controller 111 may cause the first wireless communicator 112 to communicate the gathered information (as a response to the status request) to the gateway 120 via the first gateway wireless communicator 122. In yet another instance, the gateway 120 may transmit a wakeup signal to the lock unit 110 via the first gateway wireless communicator 122 and the first wireless communicator 112. The wakeup signal may be transmitted when a high bandwidth data transfer needs to take place between the lock unit 110 and the gateway 120. After the wakeup signal is received, the lock controller 111 may activate power to the second wireless communicator 114 of the lock unit 110. The second wireless communicator 114 may then receive high bandwidth data transfer requests from the gateway 120 via the second gateway wireless communicator 124 so as to communicate data that is high bandwidth data.

In some embodiments, packets or frames including low bandwidth data transfer requests and/or signals may be communicated between the first wireless communicator 112 and the first gateway wireless communicator 122. The packets or frames may have reduced header size to enable low data rate communications. In addition, the requests and/or signals may include compressed or lightweight commands, which may further reduce the amount of data to the communicated between the first wireless communicator 112 and the first gateway wireless communicator 122. For instance, the gateway 120 may communicate a packet containing a lock or unlock signal to the lock unit 110. The packet may include an identifier (ID) for the lock unit 110 in a header portion and a lock or unlock command in a payload portion.

As discussed previously, the lock controller 111 may activate power to the second wireless communicator 114 in response to a wakeup signal received via the first wireless communicator 112. The gateway controller 121 may operate the second gateway wireless communicator 124 to send high bandwidth data transfer requests to the second wireless communicator 114 such that the lock unit 110 performs a second set of functions/operations. The high bandwidth data transfer requests may include a software and/or firmware update for the lock unit 110 or an update to an access list stored at the lock unit 110. For instance, the gateway 120 may transmit information such as an updated access list and/or a software and/or firmware update to the lock unit 110 via the second gateway wireless communicator 124 and the second wireless communicator 114. After the request is received by the lock unit 110, the information may be stored and/or updated on a memory 116 of the lock unit 110.

In some embodiments, the gateway controller 121 may be operatively coupled to a power source 126 that provides power to the gateway. For example, the power source 126 may include a hard wired power connection to a separate power system, one or more batteries and/or battery packs such as primary and/or secondary batteries, an energy harvesting system, and/or any suitable combinations of the above noted power sources.

In one embodiment, a gateway 120 may include a second user input device 125 coupled to a gateway controller 121 to allow a user to provide input (e.g., a lock-down code) on the gateway 120. In some instances, based on the input, the gateway 120 may operate a first gateway wireless communicator 122 to transmit a lock or unlock signal to the one or more associate lock units. For example, in situations where a lock-down, or other operation or status inquiry, is desired, the gateway 120 may transmit a lock signal or other command to each lock unit via the first wireless gateway communicator 122 and the corresponding first wireless communicators 112. Each lock unit may in turn communicate perform the desired operation and/or communicate the desired status information in response to the received signal.

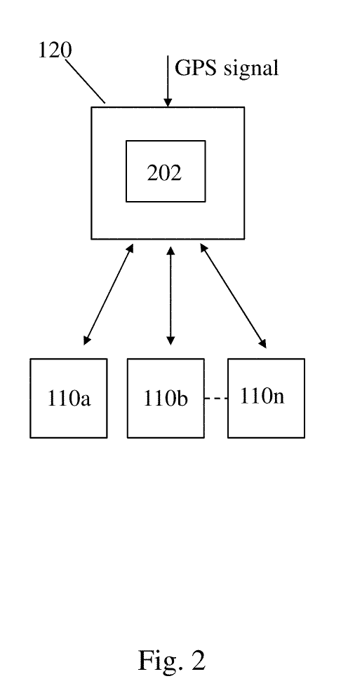

In some embodiments, as shown in FIG. 2, a gateway 120 may communicate with a number of lock units 110a, 110b, . . . , 110n, where each lock unit has components that are similar to the components of the lock unit 110 of FIG. 1. The gateway 120 may operate the first gateway wireless communicator 122 to transmit low bandwidth data transfer requests either individually or collectively to the first wireless communicators 112 associated with each lock unit. The gateway 120 may operate also operate the second gateway wireless communicator 124 to transmit high bandwidth data transfer requests either individually or collectively to the second wireless communicators 114 associated with each lock unit.

In some embodiments, the lock units 110a, 110b, . . . , 110n are synchronized with the gateway 120. The gateway 120 may be synchronized to an external timing source, such as GPS (Global Positioning System). For instance, as shown in FIG. 2, the gateway 120 may include a GPS receiver 202 that receives a GPS signal. The gateway's internal clock may be synchronized with the GPS clock received in the GPS signal. The gateway's timing information may then be used by the lock units 110a, 110b, . . . , 110b to synchronize time.

In one embodiment, the gateway 120 may be located on a tower outside a building, on the building, or any other location where it can better receive the GPS signal. In other embodiments, where the gateway 120 may be located inside a building, the GPS signal may be transmitted to the gateway from a remotely located GPS receiver using any appropriate form of communication. Alternatively, in instances where a GPS signal is not used, the lock units 110a, 110b, . . . , 110n may be synchronized with the gateway 120 via an Ethernet-based time synchronization protocol or other suitable time synchronization protocol.

According to various embodiments, a lock system may include a plurality of gateways 120 and a plurality of lock units 110. In one embodiment, each gateway may be configured to communicate with a corresponding subset of lock units. For example, a first gateway may be configured to communicate with a first subset of lock units, a second gateway may be configured to communicate with a second subset of lock units, and so on. In some scenarios, each subset of lock units may be synchronized with the corresponding gateway. Appropriate numbers of lock units that may be included in each subset of lock units may be between or equal to 2 and 300, 50 and 200, or any other appropriate number of lock units as the disclosure is not so limited. In some other scenarios, the plurality of gateways may be synchronized with each other to allow for redundancy in communications between the gateways and the lock units. In the above example, if the first gateway and the second gateway are synchronized and a fault causes the first gateway to go offline, the first subset of lock units may synchronize and communicate with the second gateway, at least until the first gateway is back online. It should be understood that any appropriate number of gateways may be synchronized with one another and they may be in communication with any number of different lock units including between or equal to 500 and 3000 lock units, 1000 and 3000 lock units, and/or any other appropriate number of lock units as the disclosure is not so limited.

Depending on the particular application, a combination of the two above-noted embodiments may be used. For example, two or more gateways may be synchronized with one another and associated with a first subset of lock units and two or more separate gateways may be synchronized with one another and associated with a second separate subset of lock units. Of course, any number of subsets of lock units and associated gateways may be used in such a combination and any number of lock units may be included in each subset as the disclosure is not so limited.

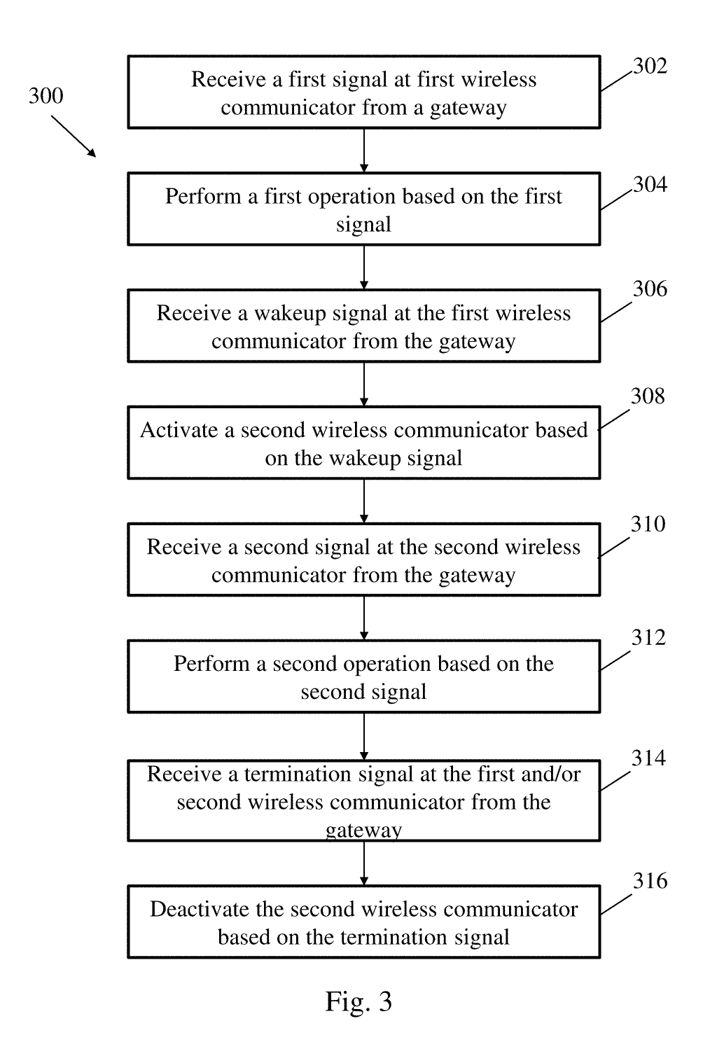

FIG. 3 is a flow chart depicting an exemplary embodiment of a method 300 for operating a lock system. A first signal may be received at a first wireless communicator of a lock unit from a gateway at block 302. For example, the first signal may include a low bandwidth data transfer request/signal, such as, a lock or unlock signal for the lock unit. A first operation may be performed based on the first signal at block 304. For example, based on the lock or unlock signal, a lock controller may operate a lock actuator to move a lock between a locked position and unlocked position, or the lock controller may operate the system to do any other desired command received from the gateway.

A wakeup signal may also be received at the first wireless communicator from the gateway at block 306. A second wireless communicator may be activated based on the wakeup signal at block 308. For example, the lock controller may activate power to the second wireless communicator in response to the wakeup signal, which may also be a low bandwidth data transfer request/signal. Once power to the second wireless communicator is activated, a second signal may be communicated to the second wireless communicator from the gateway at block 310. The second signal may include a high bandwidth data transfer request, such as, an updated access list for the lock unit as previously discussed. A second operation may then be performed based on the second signal at block 312. For example, a memory of the lock unit may be updated based on the updated access list.

In some embodiments, a termination signal may be received at the first or second wireless communicator from the gateway at block 314. The power to the second wireless communicator may be deactivated at block 316 after the second operation has been completed, a termination signal is received, and/or after a predetermined time period.

The above-described embodiments of the technology described herein may be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Also, a computing device may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards or keypads, and pointing devices, such as mice, touch pads, digitizing tablets, RFID readers, magnetic strip readers, biometric scanners, or other appropriate types of input devices. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computing devices or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Accordingly, the foregoing description and drawings are by way of example only.

What is claimed is:

1. A lock system comprising:
a lock movable between a locked position and an unlocked position;
an actuator coupled to the lock to move the lock between the locked position and the unlocked position;
a first wireless communicator configured to receive a first signal via a first wireless communication link associated with a LoRa (Long Range)-based communication network; and
a controller operatively coupled to the first wireless communicator, wherein the controller is configured to perform one or more operations of the lock system based on the first signal received from the first wireless communicator.

2. The lock system of claim 1, wherein the first signal comprises an unlock signal and the controller is configured to operate the actuator to move the lock from the locked position to the unlocked position based on the unlock signal.

3. The lock system of claim 1, wherein the first signal comprises a lock signal and the controller is configured to operate the actuator to move the lock from the unlocked position to the locked position based on the lock signal.

4. The lock system of claim 1, further comprising:
a second wireless communicator configured to receive a second signal via a second wireless communication link, wherein the second signal is different from the first signal.

5. The lock system of claim 4, wherein power to the second wireless communicator is activated in response to a wakeup signal, wherein the wakeup signal is received prior to receiving the second signal.

6. The lock system of claim 5, wherein:
the wakeup signal is received via the first wireless communicator,
the controller is further coupled to the second wireless communicator, and
the controller activates power to the second wireless communicator in response to the wakeup signal.

7. The lock system of claim 5, wherein the power to the second wireless communicator is deactivated in response to a termination signal received via the first wireless communicator.

8. The lock system of claim 1, wherein the actuator comprises a motor and wherein the controller is operatively coupled to the actuator.

9. A lock system comprising:
a plurality of lock units, wherein each lock unit of the plurality of lock units comprises:
a lock moveable between a locked position and an unlocked position;
an actuator coupled to the lock to move the lock between the locked position and the unlocked position;
a first wireless communicator configured to receive a first signal via a first wireless communication link associated with a LoRa (Long Range)-based communication network; and
a lock unit controller operatively coupled with the first wireless communicator; and
a gateway located remote from the plurality of lock units, the gateway comprising:
a gateway wireless communicator configured to transmit the first signal to the first wireless communicator; and
a gateway controller operatively coupled with the gateway wireless communicator.

10. The lock system of claim 9, wherein the first signal comprises a signal for low bandwidth data transfer between the lock unit and the gateway.

11. The lock system of claim 10, wherein:
the lock unit further comprises a second wireless communicator configured to receive a second signal via a second wireless communication link,
the second signal is different from the first signal, and
the gateway wireless communicator is configured to transmit the second signal to the second wireless communicator.

12. The lock system of claim 11, wherein the second signal comprises a signal for high bandwidth data transfer between the lock unit and the gateway.

13. The lock system of claim 11, wherein the gateway wireless communicator is further configured to transmit a wakeup signal to the lock unit via the first wireless communicator.

14. The lock system of claim 13, wherein the lock unit controller is configured to activate power to the second wireless communicator in response to the wakeup signal.

15. The lock system of claim 9, wherein the plurality of lock units are synchronized with the gateway.

16. The lock system of claim 15, wherein the gateway is synchronized with an external timing source.

17. The lock system of claim 9, further comprising at least two gateways including a first gateway and a second gateway, wherein:
the plurality of lock units comprise a first subset of lock units and a second subset of lock units,
the first subset of lock units configured to communicate with the first gateway and the second subset of lock units configured to communicate with the second gateway.

18. The lock system of claim 9, wherein the actuator comprises a motor and wherein the controller is operatively coupled to the actuator.

19. A method of operating a lock system, the method comprising:
receiving, at a first wireless communicator of a lock unit, a first signal from a gateway, wherein the first wireless communicator is configured to communicate via a first wireless communication link associated with a LoRa (Long Range)-based communication network;
receiving, at the first wireless communicator, a wakeup signal from the gateway via the first wireless communication link;
in response to the wakeup signal, activating a second wireless communicator of the lock unit, wherein the second wireless communicator is configured to communicate via a second wireless communication link different from the first wireless communication link; and
receiving, after the second wireless communicator is activated, a second signal from the gateway at the second wireless communicator.

20. The method of claim 19, wherein:
the first signal comprises a signal for low bandwidth data transfer between the lock unit and the gateway, and
the second signal comprises a signal for high bandwidth data transfer between the lock unit and the gateway.

21. The method of claim 19, wherein:
the first signal includes at least one of a lock and unlock signal for the lock unit, and
the second signal includes at least one of a software update for the lock unit, a firmware update for the lock unit, and an update to an access list stored at the lock unit.

22. The method of claim 19, further comprising:
receiving, at the first wireless communicator, a termination signal from the gateway via the first wireless communication link; and
in response to the termination signal, deactivating the second wireless communicator of the lock unit.
